(19) United States
(12) Patent Application Publication
(10) Pub. No.: US 2014/0250745 A1
(43) Pub. Date: Sep. 11, 2014

(54) Solar Digital Display for Vehicle

(71) Applicant: Eric Foltz, Huntington Beach, CA (US)

(72) Inventor: Eric Foltz, Huntington Beach, CA (US)

(21) Appl. No.: 13/790,572

(22) Filed: Mar. 8, 2013

(51) Int. Cl. G09D 3/12

(52) U.S. Cl. CPC G09D 3/12
USPC 40/107

(57) ABSTRACT

A solar digital display device for application to an automobile windshield includes a mounting member having a front side and a back side, the back side having adhesive to adhere to the automobile windshield. A housing includes a front portion and an opposed rear portion, the housing rear portion being removably coupled to the front side of the mounting member such that the housing is movable between a captive configuration coupled to the mounting member and a released configuration displaced from the mounting member. A first electronic display is operatively coupled to the housing front portion and configured to display indicia indicative of a calendar date. A solar power source is coupled to the housing rear portion and electrically connected to the first electronic display. The housing is removable from the mounting member so as to modify the date or mileage display.

### BACKGROUND OF THE INVENTION

The present invention relates generally to electronic display devices and, more particularly, to a solar-powered digital display having an adhesive attachment to an inside surface of an automobile windshield.

Automobiles should be routinely “serviced,” meaning that they should have important fluids such as oil, transmission fluid, water, and the like checked and perhaps completely changed in order for the engine to run efficiently and avoid costly repairs. In addition, other vehicle components such as windshield wipers, lighting components, tires, and the like should also be inspected and replaced when needed. The burden typically falls on the vehicle owner to remember to service his automobile regularly, such as after every 3,000 miles of driving or after a predetermined number of weeks or months.

Various devices have been proposed and used in the past for assisting a driver in remembering to have the automobile serviced regularly. For instance, an adhesive sticker may be adhered to a corner of the windshield and include a future odometer mileage after which the vehicle should be brought in for service. Or, a note may be penciled in on a calendar or card indicating the date of the next service appointment. Although assumably effective for their intended purposes, the existing means for reminding a driver of a next service appointment are less than optimal in use. For instance, a typical adhesive reminder sticker must be removed and replaced each time the vehicle is serviced, becomes faded or mutilated, or does not include both a future odometer reading and predetermined future service date.

Therefore, it would be desirable to have a solar powered digital display device that may be coupled permanently to the inside of a vehicle windshield and that indicates both a future odometer reading and a future date indicative of a next service appointment. Further, it would be desirable to have solar powered digital display device having one or two electronic display devices that are easy to read and which can be modified to reflect a next service appointment. In addition, a preferred digital display device includes a solar power component that collects energy from the sun while the device is attached to the windshield. A preferred device would also be removable from the base that is mounted to the windshield such as while a new odometer or calendar setting is modified.

### SUMMARY OF THE INVENTION

A solar digital display device for use with an automobile windshield according to the present invention includes a mounting member having a front side and a back side, the back side having adhesive to adhere to the automobile windshield. A housing includes a front portion and an opposed rear portion, the housing rear portion being removably coupled to the front side of the mounting member such that the housing is movable between a captive configuration coupled to the mounting member and a released configuration displaced from the mounting member. A first electronic display is operatively coupled to the housing front portion and configured to display indicia indicative of a calendar date.

A solar power source is coupled to the housing rear portion and electrically connected to the first electronic display. The housing is removable from the mounting member so as to conveniently modify the date or mileage display while the mounting member remains affixed to the windshield.

Therefore, a general object of this invention is to provide a solar powered digital display device that may be mounted to an inside surface of a vehicle windshield and that includes a digital display indicating an odometer and/or calendar date for a next service date.

Another object of this invention is to provide a solar powered digital display device, as aforesaid, in which the electronic display devices may be selectively releasable from the base that is adhesively adhered to the windshield, such as while modifying the odometer and/or calendar date.

Still another object of this invention is to provide a solar powered digital display device, as aforesaid, having a solar cell positioned to collect solar energy while the device is adhered to the window, the solar energy being converted to electricity used to energize the digital displays.

Yet another object of this invention is to provide a solar powered digital display device, as aforesaid, that is easy to read, easy to adhere to a windshield, and durable.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of a solar powered digital display device according to a preferred embodiment of the present invention;

FIG. 2 is a front view of the digital display device as in FIG. 1;

FIG. 3 is a rear view of the digital display device as in FIG. 1;

FIG. 4 is a perspective view of the digital display device as in FIG. 3 with the housing removed from the mounting member;

FIG. 5 is an exploded view of the digital display device as in FIG. 1;

FIG. 6a is a front view of the circuit board and electronic display devices;

FIG. 6b is a rear view of the circuit board and electronic display; and

FIG. 7 is a block diagram of the electronic components of the present invention.

### DESCRIPTION OF THE PREFERRED EMBODIMENT

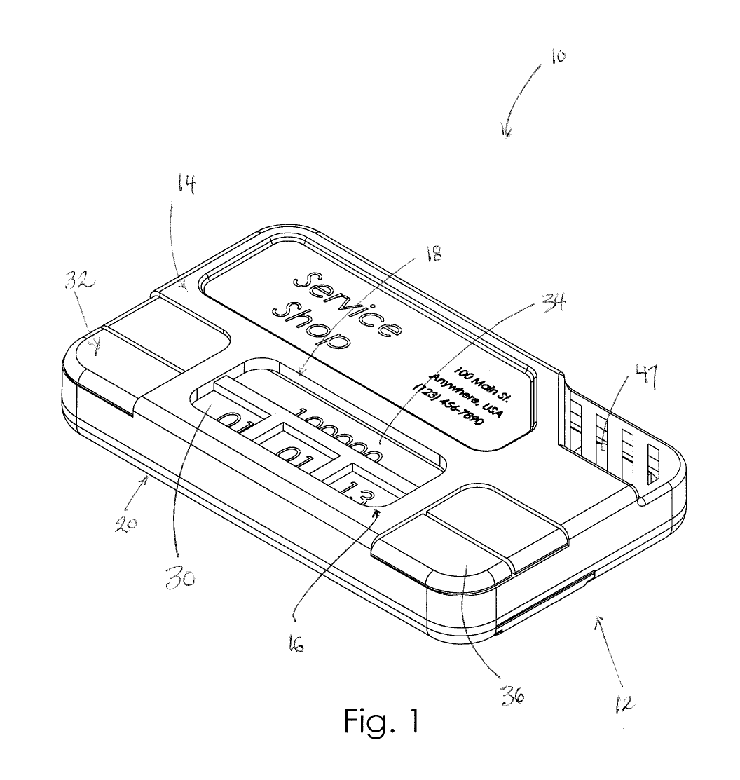

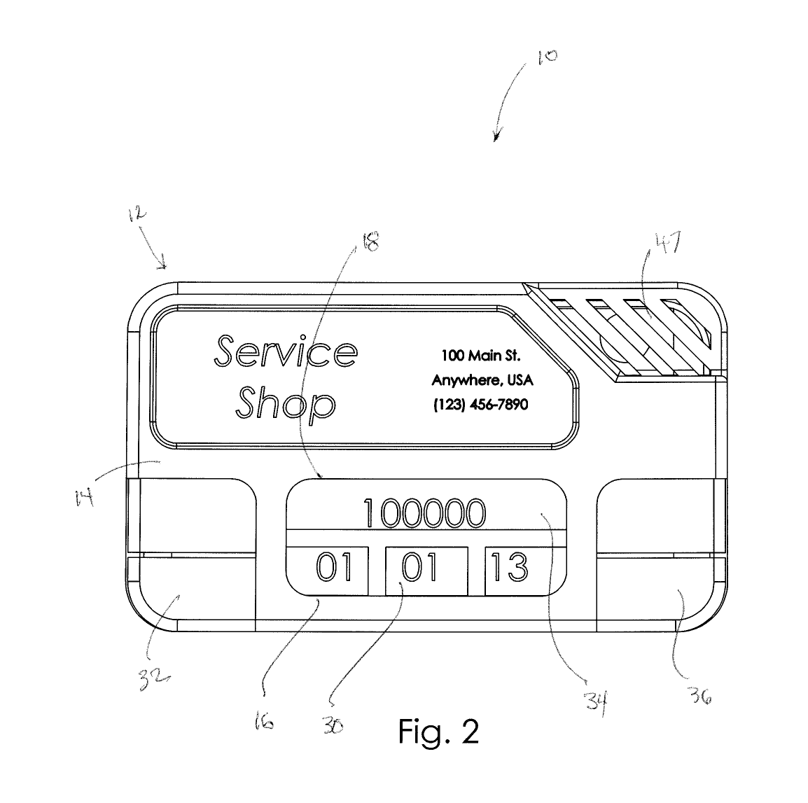

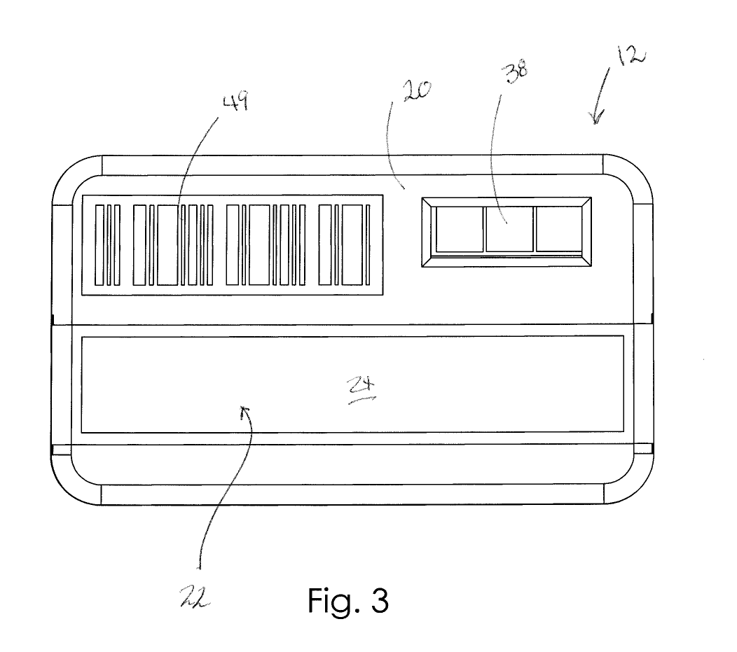

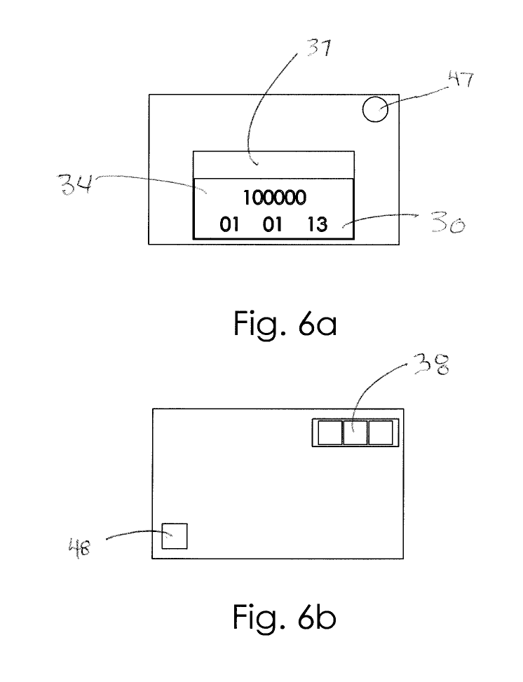

A solar digital display device according to a preferred embodiment of the present invention will be described in detail with reference to FIGS. 1 to 7 of the accompanying drawings. The solar digital display device 10 includes a housing 12, a mounting member 22, at least a first electronic display device 30, and a solar power source 38 that powers the first electronic display device 30.

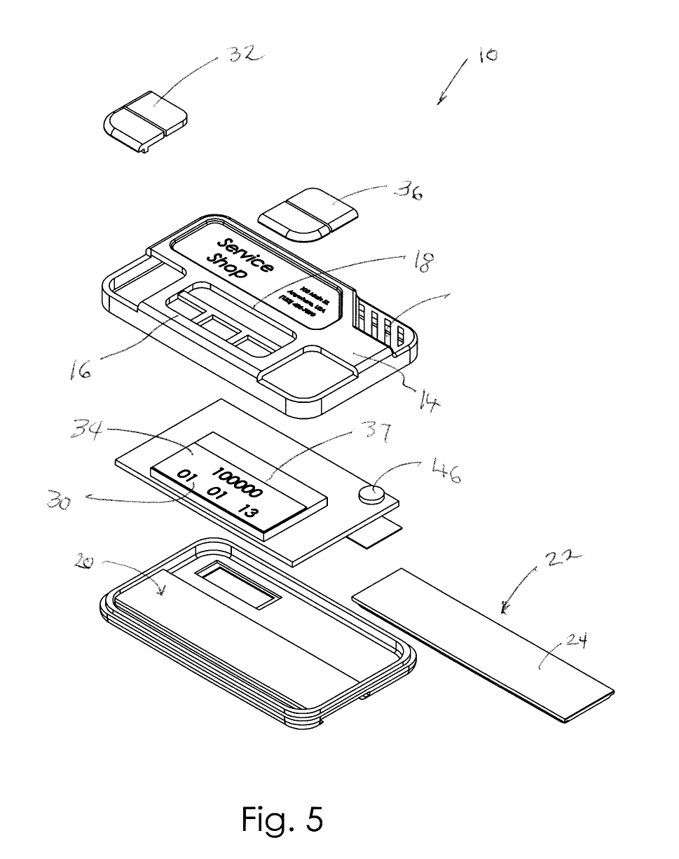

The housing 12 includes a front portion 14 releasably coupled to a rear portion 20 (FIG. 5). The front portion 14 may include a plurality of side walls such that the front and rear portions, when coupled together, define an interior area therebetween so as to encase various components as will be described below. The front portion 14 defines at least a first window 16 through which some components positioned in the interior area may be seen from outside of the housing 12. In one embodiment, the front portion 14 defines a second window 18 through which other components situated within the housing 12 may be viewed from outside of the housing 12.

The mounting member 22 may include an elongate configuration having opposed ends. The mounting member 22 also includes a front side and a back side 24. The back side 24 is configured to selectively adhere to an automobile windshield, in a manner as vehicle service reminder stickers that are sometimes placed in the upper left corner of the inside surface of a car's windshield. More particularly, the back side 24 of the mounting member 22 may include an adhesive surface configured to stick firmly to a glass surface (e.g. a vehicle windshield). It is understood that the back side 24 of the mounting member 22 may be initially covered by a strip of wax paper or the like prior to use so as to preserve the adhesive until it is applied to the windshield.

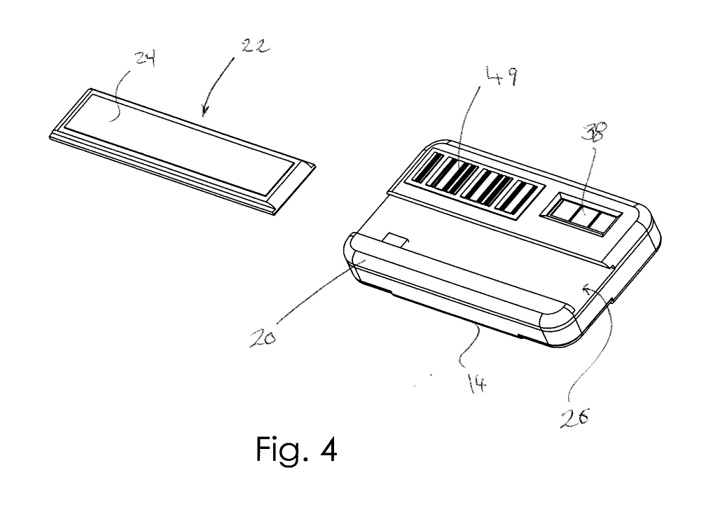

The rear portion 20 of the housing 12 is removably coupled to the front side of the mounting member 22. The rear portion 20—and the entire housing 12 for that matter—is selectively removable from the mounting member 22. The housing 12, therefore, may be removed, such as when setting a new calendar date for the next service visit or such like. The housing 12 is movable between a captive configuration in which the rear portion 20 is attached to the mounting member 22 (a “captive configuration”) and a released configuration displaced from the mounting member 22. With specific reference to FIG. 4, an outer surface of the rear portion 20 of the housing 12 defines a channel 26 that is configured to selectively receive the mounting member 22 at the captive configuration. The mounting member 22 is configured to slidably engage the channel 26 and to move the housing slidably between captive and released configurations.

The first electronic display device 30 may be a liquid crystal display (LCD) or other digital screen configured to digitally display data. The solar digital display 10 includes a first input 32 electrically connected to the first electronic display device 30. The first input 32 may be a button, knob, dial, touch screen, or the like that receives data from a user. In one embodiment, the first input 32 may be a flash drive or other portable data storage media that may connect to the first electronic display device 30 such as through a USB connection. The first electronic display device 30 is configured, such as with circuitry, wires, or programming, to receive a calendar date or to edit a previously entered calendar date. It is understood that after servicing a vehicle, the service technician may set the first electronic display device 30 to reflect a future vehicle mileage at which to remind a user visually that the vehicle should be serviced.

In one embodiment, the solar digital display 10 may include a processor 42 in data communication with a memory 44. The memory may include programming instructions and data structures for storing a current calendar date and other data as will be described in more detail later. The processor 42 and memory 44 are situated in the interior area of the housing 12. In fact, the processor 42, memory 44, and first electronic display device 30 may be combined onto a single circuit board 37 (FIG. 5).

In one embodiment, the first electronic display device 30 may be operatively coupled to an outer surface of the front portion 14 of the housing 12. In this configuration, the first electronic display device 30 may constitute the front portion itself. In a preferred embodiment, however, the first electronic display device 30 is situated in the housing interior area and positioned so as to be viewable through the first window 16 of the housing 12 (FIG. 1). The first electronic display device 30 is configured to digitally display a calendar date. For instance, the first electronic display device 30 may display 3 15 13 when indicating Mar. 15, 2013.

The solar digital display device 10 may also include an alert member 47 in data connection with the processor 42. The alert member 47 may be a speaker and may output an audible sound when energized by the processor 42 to do so. In this embodiment, the programming when executed by the processor 42, causes the processor 42 to determine if a current calendar date is later in time that a calendar date being displayed by the first electronic display device 30. If so, then the processor 42 energizes the alert member 47. Correspondingly, the processor 42 may cause a predetermined audible sound stored in memory 44 to be directed to the alert member 47 for output thereby.

It is understood that a calendar date of a future service appointment may have been saved in memory 44 after being entered by a user using the first input 32. It is further understood that the predetermined audible sound may have been pre-recorded and stored in memory 44 at the point of manufacture or uploaded to memory 44 through a USB connection or the like. In one embodiment, the alert member 47 may be a visual alert, such as causing the first display device to display a colored screen, animation, flashing lights, or the like so as to gain the attention of a driver.

The solar digital display device 10 may include a second electronic display device 34 operatively coupled to the front portion 14 of the housing 12 in a manner substantially similar to the first electronic display device 30 described previously. In a preferred embodiment, the front portion 14 of the housing 12 defines a second window 18. The second electronic display device 36 is situated in the interior area of the housing 12 and positioned so as to be viewable through the second window 18 (FIG. 1). The first and second electronic display devices 30, 34 may have a unitary configuration (FIG. 5). The second electronic display device 34 is configured, such as with circuitry, wires, or programming, to receive and digitally display a numeric value indicative of a vehicle mileage. The processor 42 and memory 44 may be configured with programming or circuitry to store the vehicle mileage displayed on the second electronic display device 34 to a data structure in memory 44.

The solar digital display device 10 includes a second input 36 electrically connected to the second electronic display device 34. The second input 36 may be a button, knob, dial, touch screen, or the like that receives data from a user. In one embodiment, the second input 36 may be a flash drive or other portable data storage media that may connect to the second electronic display device 34 such as through a USB connection.

The solar power source 38 may also be referred to as a solar cell 38. The solar cell 38 is coupled to the outer surface of the rear portion 20 of the housing 12 (FIG. 4). The solar cell 38 is generally adjacent the back side 24 of the mounting member 22. In one embodiment, the solar cell 38 may be situated within the interior area of the housing 12, the rear portion 20 of the housing 12 defining an opening through which the solar cell 38 is visible. In use, the solar cell 38 receives and collects solar energy through a vehicle windshield to which the mounting member 22 is attached. The collected solar energy may then be stored as described below.

The solar digital display 10 may include a battery 46 positioned in the interior area of said housing 12 and electrically connected to the solar power source 38. The battery 46 may be a rechargeable battery configured to store electrical energy collected by the solar cell 38. It is understood that additional circuitry or electronic components may also be included that are specifically adapted to convert collected solar energy into electricity in a form capable of being stored in the rechargeable battery 46 and then used to energize the electronic display devices.

The solar digital display device 10 may include a bar code 49 situated on the outer surface of the rear portion 20 of the housing 12. The bar code 49 is configured to code vehicle history data such that, when scanned, by appropriately configured hardware and software at an automobile service center, provides information to a technician that may include, although not limited to, a vehicle identification number (“VIN”), last date of service, and other vehicle history data. Updated vehicle information may be transferred back to the bar code or a new bar code strip may be generated and adhesively attached to the housing rear portion 20, so as to be available the next time the vehicle is brought in for service. In some embodiments, a magnetic strip may be used as an alternative to a bar code, the magnetic strip being configured to store vehicle information that may be read and then viewed by appropriate corresponding data processing equipment as is known in the art.

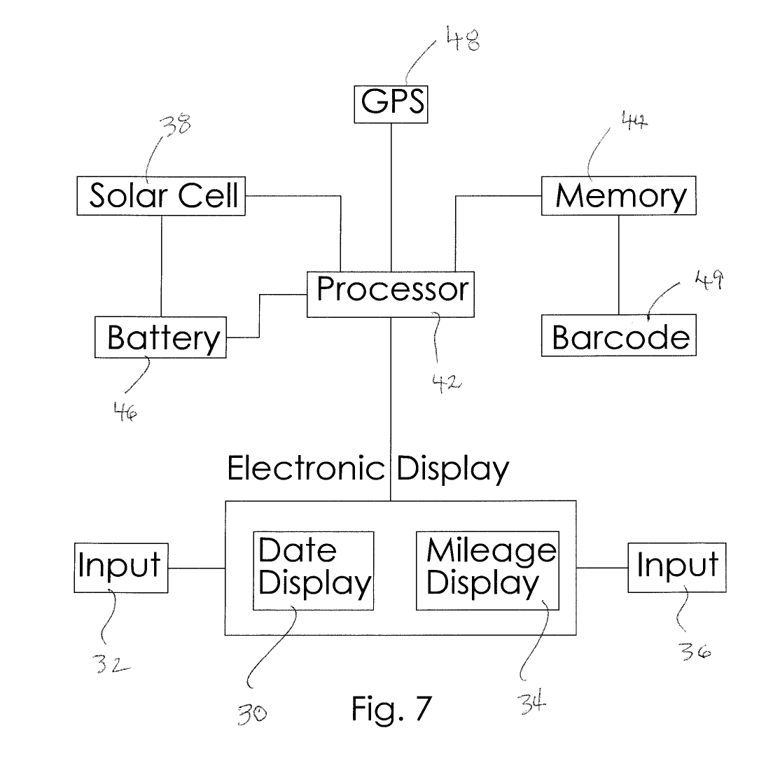

In one embodiment, the solar digital display 10 may include a geographic location identifying module 48 situated in the housing interior area and in data communication with the processor 42. The location identifying module 48 is referred to in FIG. 7 as a GPS module. Similar to that of smart phones and intelligent mobile devices, the location identifying module 48 is capable of identifying its own geographic coordinates using a global position network, such as the global position satellite network (“GPS”). An appropriately configured computer system is able to track the position of a respective location identifying module 48 if given respective codes unique to the device. In some embodiments, the system may track a current mileage of a vehicle when serviced and then track the increase in mileage according to ongoing global position data being generated by the location identifying module 48 as the vehicle is driven. When the current mileage is equal to the “next service due” mileage displayed on the second electronic display device 34, the solar digital display 10 may be alerted or the owner associated with the solar digital display 10 may be manually contacted by phone, e-mail, or traditional mail with notice that the vehicle needs to be serviced.

In use, a digital display device 10 may be installed in a vehicle when it is serviced by an automotive service center. Specifically, the mounting member 22 may be adhesively adhered to an inner surface of the vehicle windshield at a position to be visible to a driver yet without obstructing his vision, such as in the upper left hand corner of the windshield. Then, the entire housing 12 may be slidably removed from the mounting member 22. The first 30 and second 34 display devices may then be set to indicate to the driver a preferred time to return for another service appointment. More particularly, the first input 32 may be operated to indicate a calendar date by which to return for service. Similarly, the second input 36 may be operated to indicate a vehicle mileage at which servicing is preferred. The housing 12 may then be slidably coupled again to the mounting member 22.

The electronic display devices 30, 34 are electrically connected to the battery 46 and the battery 46 is connected to the solar cell 38. The solar cell 38 is positioned so as to collect solar energy whenever sunlight is cast upon the windshield of the car. Accordingly, collection of electricity is maximized while the electronic components of the present system draw very little power.

It is understood that while certain forms of this invention have been illustrated and described, it is not limited thereto except insofar as such limitations are included in the following claims and allowable functional equivalents thereof.

1. A solar digital display device for use with an automobile windshield, comprising:
a mounting member having a front side and a back side, said back side configured to adhere to the automobile windshield;
a housing having a front portion and an opposed rear portion, said housing rear portion being removably coupled to said front side of said mounting member such that said housing is movable between a captive configuration coupled to said mounting member and a released configuration displaced from said mounting member;
a first electronic display operatively coupled to said housing front portion and configured to digitally display a calendar date; and
a solar power source coupled to said housing rear portion and electrically connected to said first electronic display.

2. The solar digital display device as in claim 1, wherein:
said housing front portion and said housing rear portion define an interior area therebetween;
said housing front portion defines a first window; and
said first electronic display is positioned in said interior area such that said first electrical display is viewable through said first window.

3. The solar digital display device as in claim 1, wherein:
said housing rear portion defines a channel configured to selectively receive said mounting member at said captive configuration; and
said mounting member is configured to move slidably relative to said channel between said captive and said released configurations.

4. The solar digital display device as in claim 1, further comprising a first input electrically connected to said first electronic display and configured to selectively change a numeric indicia displayed thereby.

5. The solar digital display device as in claim 4, further comprising:
a memory in data communication having programming and data structures configured to store data, said memory storing a current date;
a processor in data communication with said first electronic display device and with said memory, said processor being configured to execute said programming;
an alert member electrically connected to said processor;
programming in said memory that, when executed by said processor, causes said processor to determine if a current date is past a date indicated by said first electronic display device; and
programming in said memory that, when executed by said processor, causes said processor to actuate said alert member if said current date is past the date indicated by said first electronic device.

6. The solar digital display device as in claim 5, wherein said alert device member is an audio device.

7. The solar digital display device as in claim 5, wherein said alert device member is visual display.

8. The solar digital display device as in claim 1, further comprising a second electronic display operatively coupled to said housing front portion and configured to digitally display a vehicle mileage.

9. The solar digital display device as in claim 2, wherein:
said housing front portion defines a second window; and
said second electronic display is positioned in said interior area such that said second electrical display is viewable through said second window.

10. The solar digital display device as in claim 9, further comprising a second input electrically connected to said second electronic display and configured to selectively change a numeric indicia displayed thereby.

11. The solar digital display device as in claim 10, wherein said back side of said mounting member includes an adhesive configured to adhere to the automobile windshield, said housing being selectively removable from said mounting member when said mounting member remains adhered to said automobile windshield.

12. The solar digital display device as in claim 1, wherein said back side of said mounting member includes an adhesive configured to adhere to the automobile windshield, said housing being selectively removable from said mounting member when said mounting member remains adhered to said automobile windshield.

13. The solar digital display device as in claim 2, further comprising a battery situated in said interior area electrically connected to said solar power source and configured to store energy collected by said solar power source.

14. The solar digital display device as in claim 1, further comprising a bar code positioned on said rear portion configured to encode vehicle identification and historical data.

15. The solar digital display device as in claim 8, wherein said first electronic display and second electronic display have a unitary construction.

16. The solar digital display device as in claim 1, further comprising a location identifying module in said housing that is configured to be tracked by an external electronic system having identifying data associated with said location identifying module.
